(19) United States
(12) Patent Application Publication
(10) Pub. No.: US 2013/0156288 A1
(43) Pub. Date: Jun. 20, 2013

(54) Systems And Methods For Locating Characters On A Document

(71) Applicant: DE LA RUE NORTH AMERICA INC., Irving, TX (US)

(72) Inventors: Anand Prasad Chinnaswamy, Karnataka (IN); Shiju Poovakurussi Kizhakekara, Kerala (IN); Rakesh Simpi, Karnataka (IN); Karguvel Rajan Ramachandran, Tamil Nadu (IN)

(73) Assignee: DE LA RUE NORTH AMERICA INC., Irving, TX (US)

(21) Appl. No.: 13/715,249

(22) Filed: Dec. 14, 2012

(30) Foreign Application Priority Data
Dec. 19, 2011 (IN) 3561/MUM/2011

(51) Int. Cl. G06K 9/00

(52) U.S. Cl. CPC G06K 9/00469
USPC 382/135

(57) ABSTRACT

Systems and methods for locating characters on a document are provided. In one embodiment, a method for locating characters on a document includes receiving an image of a document, identifying a set of character candidate forms in the image based on image intensity data, identifying a set of characters from the set of character candidate forms based on spatial characteristics of the set of character candidate forms, and outputting a location of the set of characters.

### TECHNICAL FIELD

The illustrative embodiments relate generally to locating characters on a document, and more particularly, to locating characters on a document using an image of the document.

### BACKGROUND

Many different types of documents, such as banknotes (e.g., paper money, plastic money, etc.), checks, legal-related documents, or any other type of document, include one or more characters (e.g., numbers, letters, or symbols) printed or affixed thereto. Such characters may reveal information about the document with which they are associated, as well as other data that a user may desire to know. By way of non-limiting example, many banknotes, or currency, from various countries include a serial number that may be used to identify the banknote on which the serial number is printed. Current systems may fail to effectively, accurately, or efficiently locate characters on documents. For example, some current systems may fail to take into account background, variation when locating characters on a document. Current systems may be sub-optimal for a variety of other reasons as well.

### SUMMARY

According to an illustrative embodiment, a method for locating characters on a document includes receiving an image of a document, identifying a set of character candidate forms in the image based on image intensity data, identifying a set of characters from the set of character candidate forms based on spatial characteristics of the set of character candidate forms, and outputting a location of the set of characters.

According to another illustrative embodiment, a method for locating a serial number on a banknote includes receiving an image of a banknote, identifying a set of character candidate forms in the image based on image intensity data, identifying a serial number from the set of character candidate forms based, on spatial characteristics of the set of character candidate forms, and outputting a location of the serial number.

According to another illustrative embodiment, a document character locator implemented by a computing device includes a composite image generator to receive am image of a document and convert the image into a composite image of the document, an intensity thresholding module to identify a set of character candidate forms in the composite image based on image intensity data, a spatial analysis engine to identify a set of characters from the set of character candidate forms based on spatial characteristics of the set of character candidate forms, and an anchor module to output a location of the set of characters.

### BRIEF DESCRIPTION OF THE DRAWINGS

FIG. 1 is a schematic, pictorial representation of a document character locator system according to an illustrative embodiment;

FIG. 2 is a schematic, block diagram of a document character locator according to an illustrative embodiment;

FIGS. 3A-G are schematic, plan views of a document at various stages of a process implemented by the document character locator to locate one or more characters on the document according to an illustrative embodiment;

FIG. 4 is a flowchart of a process for locating characters on a document according to an illustrative embodiment;

FIG. 5 is a flowchart of another process for locating characters on a document according to an illustrative embodiment; and

FIG. 6 is a schematic, block diagram of an example computing device on which the illustrative embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

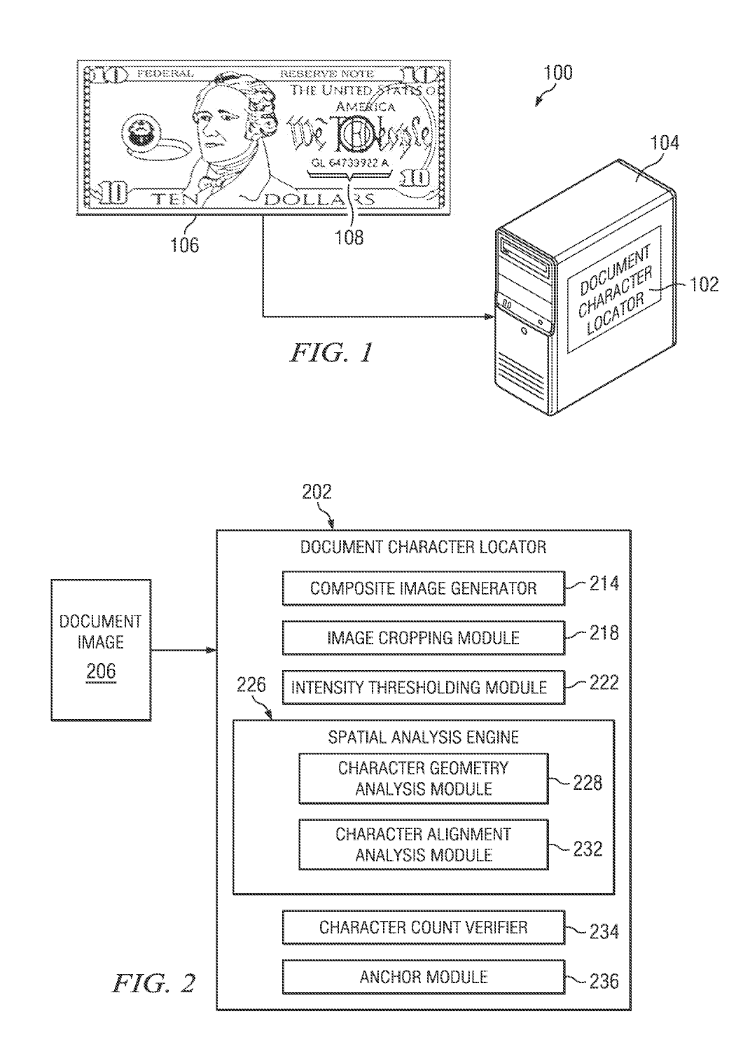

Referring to FIG. 1, an illustrative embodiment of a document character locator system 100 includes a document character locator 102 implemented on a computing device 104. The document character locator 102 may receive a document image 106 and locate a set of characters 108 on the document image 106. As used herein, including in the claims, the term “set” encompasses a quantity of one or more. As used herein, a “character” may include a letter, number, symbol, image, etc. or any combination thereof.

In one illustrative embodiment, the document character locator 102 may receive an image 106 of a document, and identify a set of character candidate forms in the image 106 based on image intensity data contained in the image 106. The document character locator 102 may then identify a set of characters 108 from the set of character candidate forms based on spatial characteristics of the set of character candidate forms. As will be described in more detail below, the spatial characteristics may include character geometry criteria, spacing parameters, as well as other spatial characteristics. After identifying the set of characters 108, the document character locator 102 may output the location of the set of characters 108. As will be described in more detail below, an anchor may be used to indicate a location of or within the set of characters 108, and this anchor may be outputted by the document character locator 102 for subsequent processing. Unless otherwise indicated, as used herein, “or” does not require mutual exclusivity.

The document on which the set of characters 108 is located may be any type of document on which the set of characters 108 may be printed, affixed, or otherwise associated in any manner, including, but not limited to, banknotes from any country of origin, financial documents (e.g., checks, money orders, travelers checks, etc.), legal-related documents, etc. In the non-limiting example of FIG. 1, the image 106 is of a banknote and the set of characters 108 is a serial number identifying the banknote. A serial number is one of many examples of characters that may be located using the document character locator 102. The serial number may include any combination of numbers, letters, symbols, etc. The serial number may be printed on the banknote in any manner, including serial numbers that “float” on the banknote, or are printed on the banknote using a separate printing step as compared to background print. It will be appreciated that the illustrative embodiments may be used to locate different serial numbers on many banknotes, regardless of whether the serial numbers are the same or differ from one another from banknote to banknote. Also, other characters on banknotes may also be located by the document character locator 102, including any fixture print, the name of a person, a number indicating the value of the currency (e.g., $5, $10, etc.), as well as any other characters, including numbers, symbols, images, or letters, that may appear on a banknote.

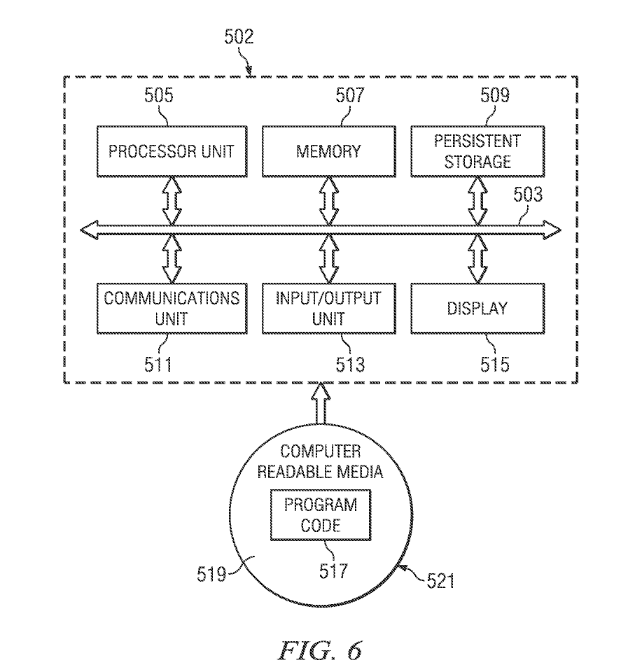

The document character locator 102, while implementable on the computing device 104, may be used, to locate characters 108 in a wide variety of contexts or environments. In one non-limiting example, the computing device 104 may be associated with a document processing machine that sorts, authenticates, manages, or otherwise processes large numbers of documents. An example document processing machine in which the document character locator 102 may be implemented may be a banknote, or currency, processing machine capable of performing one or more operations on a large volume of banknotes including, but not limited to, counterfeit detection, sorting, destroying, ordering, fitness detection, document production, as well as others. While the document character locator 102 may be used in a banknote processing machine, the document character locator 102 may also be used in other types of machines, or as a standalone application, to locate characters 108 on a wide variety of documents in other contexts or environments. Additional details regarding an example computing device, such as the computing device 104, on which the document character locator 102 may be implemented is provided below in FIG. 6.

It will be appreciated that, after the document character locator 102 locates the set of characters 108, a wide variety of post-processing steps may then be performed on the located set of characters 108, such as optical character recognition, imaging, extraction, character processing, etc. Some illustrative embodiments may be used to locate characters 108 despite background variation of the document, thus allowing the document character locator 102 to be able to locate the characters 108 despite background changes.

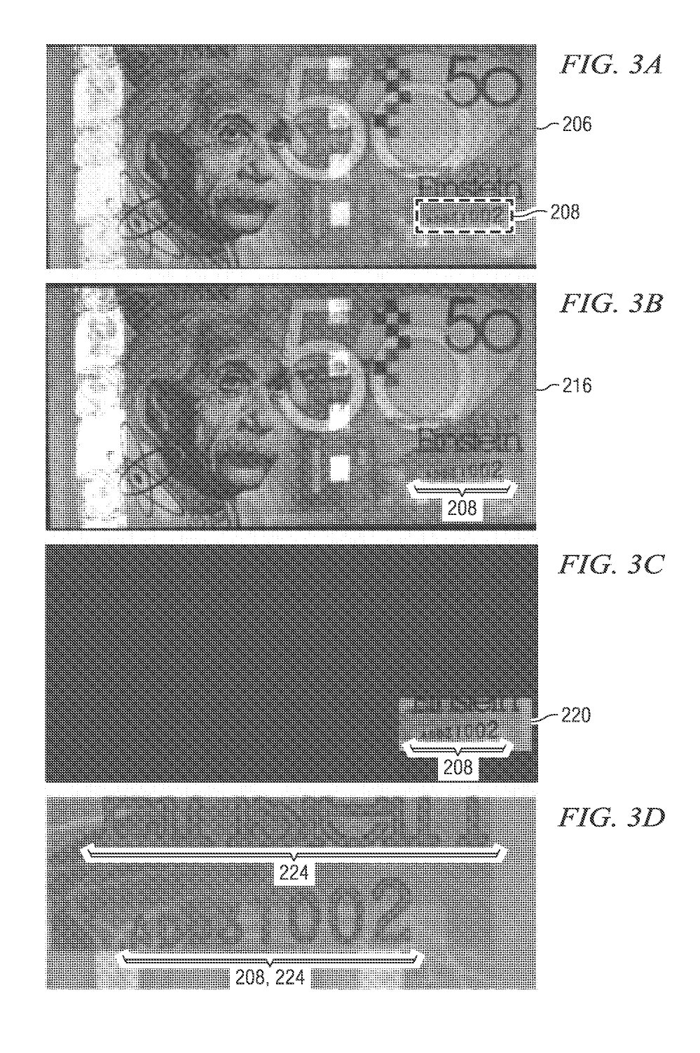

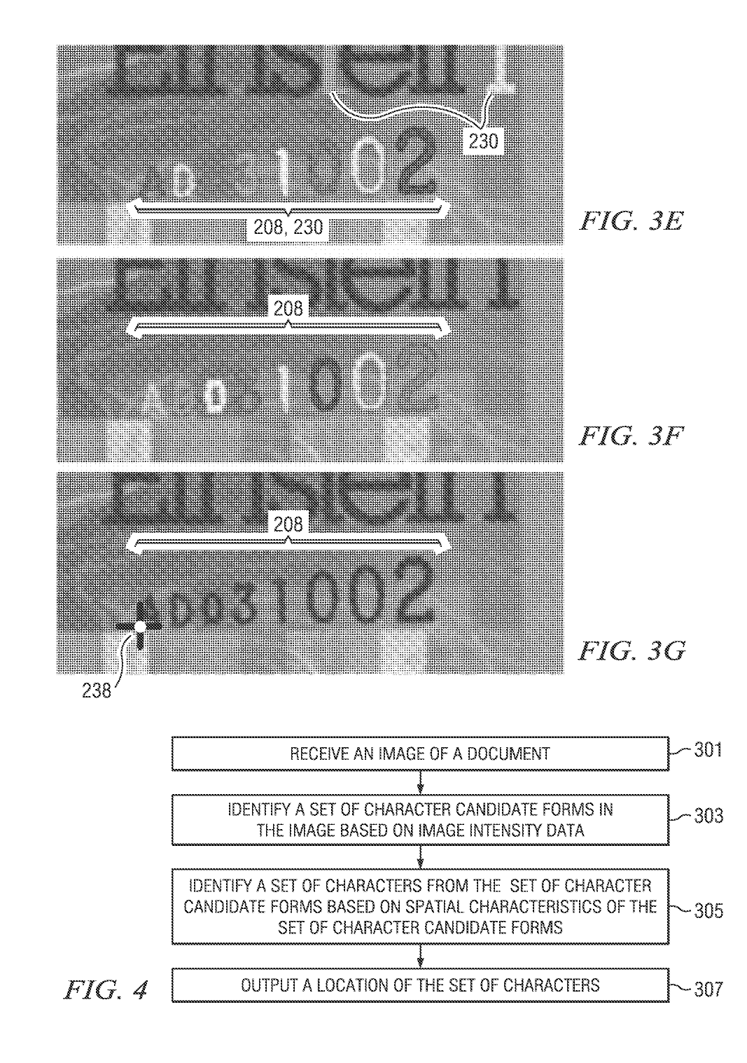

Referring to FIGS. 2 and 3A-G, an illustrative embodiment of the document character locator 202 is shown to include multiple elements or processing steps to locate a set of characters 208 on the document image 206. Elements of FIGS. 2 and 3A-G that are analogous to elements in FIG. 1 have been shown by indexing the reference numerals by 100. FIGS. 3A-G show the document image 206 as a banknote being subjected to various processing steps described herein, though it will be appreciated that the document image 206 may be of any type of document.

The document character locator 202 may include a composite image generator 214 that receives the document image 206. In one embodiment, the composite image generator 214 may convert the document image 206 into a composite image 216 of the document. In one example, the composite image 216 may increase the contrast between the set of characters 208 and the background of the document image, as compared to the original document image 206. In another example, the composite image 216 may be a single channel image. Further, the composite image 216 may be a grayscale image, while, in some cases, the original document image 206 may be a color image.

In one embodiment, the composite image generator 214 may generate the composite image 216 from the document image 206 using a set of composite image parameters. Non-limiting examples of the composite image parameters include red gain, green gain, blue gain, and offset. The composite image parameters may be used in a variety of algorithms, formulas, or processes to compute a resulting grayscale image that makes up the composite image 216. One non-limiting example of a formula that may be used to compute the grayscale intensity of pixels or portions within the composite image 216 is as follows:

gray=red gain*red+green gain*green+blue gain*blue+offset.

The red gain, green gain, blue gain, and offset composite image parameters may have any value that may be predetermined or user-defined in order to achieve desired contrast between the set of characters 208 and the background of the document image 206. To provide a non-limiting example for purposes of illustration only, the red gain may have a value of −1.2, the green gain may have a value of 2, the blue gain may have a value of −0.6, and the offset may have a value of 78, although these values may be fine-tuned or altered to achieve a desired contrast between the set of characters 208 and the background of the document image 206. It is noted that the values of the composite image parameters may vary depending on the type of document being processed, as different documents have different types of backgrounds and characters thereon. For example, the composite image parameters may be varied depending on the type of banknote (e.g., a Euro banknote vs. a U.S. dollar banknote) being processed. Also, the composite image parameters may be configured by a user during a model building process.

In yet another embodiment, the composite image 216 may be a monochrome, black-and-white, or intensity image. In this case, appropriate red, green, and blue gain values may be inputted into the formula above to yield such a black-and-white, monochrome, or intensity image. By way of non-limiting example for purposes of illustration only, the formula above may have red, green, and blue gain values as follows: gray=0.299*red+0.587*green+0.114*blue. An offset may or may not be used in this type of composite image. In one embodiment, if the composite image generator 214 detects that the document image 206 is already in a monochrome format, the composite image generator 214 may forego from converting the monochrome document image 206 into the composite image 216, thereby allowing the monochrome document image 206 to be processed as described herein. It will be appreciated that numerous formulas may be used to compute the composite image 216 that allow the set of characters 208 to be contrasted or used in subsequent processing steps.

The document character locator 202 may include an image cropping module 218. The image cropping module 218 may crop the composite image 216 to a character analysis region 220, shown in FIG. 3C. The character analysis region 220 may be a region that is a candidate for containing the set of characters 208. The character analysis region 220 may be predetermined based on the particular type of document being analyzed; for example, the character analysis region 220 may be predetermined to be the region of a banknote in which a serial number is predicted or known to be located. The character analysis region 220 may also be predefined by a user during a model building process.

By cropping the composite image 216 to a character analysis region 220, subsequent processing for locating the set of characters 208 may, in some cases, be sped up because a smaller region (i.e., the character analysis region 220) may be processed and analyzed for locating the set of characters 208. In an alternative embodiment, the image cropping module 218 may crop the document image 206 before the composite image generator 214 converts the document image 206 into the composite image 216; in this case, only the character analysis region 220 is converted to a composite image. In yet another embodiment, the document image 206 may be cropped to a character analysis region 220 by the image cropping module 218, and the character analysis region 220 may not be converted to a composite image at all.

In one embodiment, the document character locator 202 may also contain an intensity thresholding module 222, which may identify a set of character candidate forms, or blobs, 224, shown in FIG. 3D, in the character analysis region 220 of the composite image 216 based on image intensity data. The image intensity data may be values for respective pixels or portions of the composite image 216 of the intensity of that particular pixel or portion. For example, in an embodiment in which the composite image 216 is an eight-bit grayscale image, each of the pixels or portions of the composite image 216 may have a value in a range of 0-255 (2⁸). It will be appreciated that the actual intensity value (e.g., 0, 100, 255, 1000, etc.) or intensity value range may vary based on the type of composite image 216, but the intensity value may reflect the intensity of the pixel or portion with which the value is associated.

In one embodiment, the intensity thresholding module 222 may use a set of threshold parameters applied to the image intensity data of the character analysis region 220 to identify the set of character candidate forms 224. By way of non-limiting example, in the embodiment in which the image intensity data of the character analysis region 220 may be expressed in grayscale intensity values, the set of threshold parameters may include a minimum grayscale threshold and a maximum grayscale threshold. The intensity thresholding module 222 may then identify the set of character candidate forms 224 in the character analysis region 220 by determining the character candidate forms 224 that have grayscale intensity values that meet or exceed the minimum grayscale threshold as well as meet or are less than the maximum grayscale threshold. By way of non-limiting example, in the embodiment in which the grayscale intensity values are in a range of 0-255, the minimum grayscale threshold may be set to 60 and the maximum grayscale threshold may be set to 135; these specific values are merely by way of example, and may be varied as desired by a user. The intensity thresholding module 222 may then determine any character candidate forms 224 within the character analysis region 220 that have grayscale intensity values meeting or exceeding 60, and grayscale intensity values meeting or less than 135. In yet another embodiment, the set of threshold parameters may include at least one of a minimum grayscale threshold or a maximum grayscale threshold, and the intensity thresholding module 222 may then identify the set of character candidate forms 224 in the character analysis region 220 by determining the character candidate forms 224 that either have grayscale intensity values that meet or exceed the minimum grayscale threshold or meet or are less than the maximum grayscale threshold.

Turning to the example of FIG. 3D, the intensity thresholding module 222 may determine the set of character candidate forms 224. In this particular example, the character candidate forms 224 include the serial number of a banknote, as well as the bottom half of the word “Einstein”. Determining the character candidate forms 224 in this manner may serve to differentiate the character candidate forms 224 from the background so that the character candidate forms 224 may be subject to subsequent processing to select the set of characters 208 (in this example, the banknote serial number). Determining the character candidate forms 224 in this manner may also serve to narrow the forms being analyzed as candidates to be the desired set of character 208 (e.g., a banknote serial number). Thus, in some cases, the intensity thresholding module 222 may identify some character candidate forms 224 other than the set of characters 208 desired to be located by the document character locator 202, as shown in FIG. 3D.

It will be appreciated that the intensity thresholding module 222 may identify the set of character candidate forms 224 directly from the document image 206, in an alternative embodiment. In yet another embodiment, the intensity thresholding module 222 may identify character candidate forms 224 from the composite image 216 before the composite image 216 is cropped by the image cropping module 218. Indeed, the intensity thresholding module 222 may be applied in a variety of ways, or in a variety of steps in a sequence, according to the illustrative embodiments.

In one embodiment, the document character locator 202 may include a spatial analysis engine 226, which may identify the set of characters 208 from the set of character candidate forms 224 based on spatial characteristics of the set of character candidate forms 224. Spatial characteristics include, but are not limited to, geometric attributes of the set of character candidate forms 224, spacing in any direction between individual forms in the set of character candidate forms 224, as well as any other spatial characteristic. The spatial analysis engine 226 may use any of these spatial characteristics to narrow the character candidate forms 224 to the set of characters 208 desired to be located (in the example of FIGS. 3A-G, the serial number 208).

The spatial analysis engine 226 may include a character geometry analysis module 228, which may filter the set of character candidate forms 224 to form a set of filtered character candidate forms 230, an example of which is shown in FIG. 3E. In identifying the set of filtered character candidate forms 230 from the set of character candidate forms 224, the character geometry analysis module 228 may use a set of character geometry criteria. The character geometry criteria may include height criteria, width criteria, or any other geometrical criteria that may filter the set of character candidate forms 224 to form the set of filtered character candidate forms 230, as well as any combination thereof. For example, the character geometry criteria may include maximum width, maximum height, minimum width, and minimum height parameters, and the character geometry analysis module 228 may select the set of filtered character candidate forms 230 from the set of character candidate forms 224 that are within these minimum and maximum height and width thresholds. In yet another embodiment, the character geometry criteria may include either height criteria or width criteria, or both.

In one embodiment, the character geometry criteria may be predetermined based on known geometric quantities of the set of characters 208. For example, in the case in which the set of characters 208 is a serial number, the minimum and maximum, height and width, thresholds may be set based on the known dimensions of the characters in the serial number. In another embodiment, the minimum and maximum height and width, thresholds may be determined or set relative to or correlated with the position of the character relative to a point of reference (e.g., the location of the character in a string, the location of the character relative to a document edge or corner, the location of the character relative to another marking or feature in the document, etc.). The character geometry criteria may also be predefined during a model building process for the document character locator 202.

In the non-limiting example of FIGS. 3D and 3E, the character geometry analysis module 228 has selected a set of filtered character candidate forms 230 from the set of character candidate forms 224 such that the set of characters 208 (in this case, a serial number) and a portion of two letters in the word “Einstein” have been identified as filtered character candidate forms 230. The character geometry analysis module 228 may have selected these particular filtered character candidate forms 230 based on the dimensions of these forms and whether they have met character geometry criteria of the character geometry analysis module 228. Thus, in effect, the character geometry analysis module 228 has narrowed the character candidate forms 224 to a smaller set of forms so that these filtered forms 230 may be subsequently processed by the document character locator 202.

It will be appreciated that the character geometry criteria is in no way limited to height and width dimensions. Non-limiting examples of other types of character geometry criteria include shape, area, volume, diagonal length, circumference, form outline length, etc.

In one embodiment, the spatial analysis engine 226 may also include a character alignment analysis module 232, which may select the set of characters 208 from the set of filtered character candidate forms 230 using a set of spacing parameters. The spacing parameters may include horizontal spacing criteria and vertical spacing criteria. In one example, the horizontal spacing criteria may be a maximum horizontal distance between the centers, or other predetermined portion, of any two consecutive or adjacent filtered character candidate forms 230 for the filtered character candidate forms 230 to qualify as one of the set of characters 208. Similarly, the vertical spacing criteria may be a maximum vertical distance between the centers, or other predetermined portion, of any two consecutive or adjacent filtered character candidate forms 230 in order for the filtered character candidate forms 230 to qualify as one of the set of characters 208. Other spacing parameters may include minimum horizontal or vertical distances between filtered character candidate forms 230, as well as diagonal or other distance measurements between the filtered character candidate forms 230. Also, the spacing parameters need not be limited to consecutive filtered character candidate forms 230, as the distance may be measured between any combination of the filtered character candidate forms 230 in order for them to qualify as one of the set of characters 208.

Vertical spacing criteria may be particularly useful for detecting sets of characters (e.g., serial numbers) that are diagonal or vertical relative to one another, horizontally or vertically telescoped relative to one another, or skewed (including skewing due to image capture issues or imperfections).

Spacing parameters may be predefined by a user based on the particular type of document being analyzed, and may be defined during a model building process. For example, in the example of FIG. 3, the spacing parameters may be determined based on known or predicted distances between characters in the serial number 208 in order to eliminate some of the filtered character candidate forms 230 in FIG. 3E from being considered, characters in the serial number 208. In the particular example of FIGS. 3E and 3F, the bottom portions of two letters in the word “Einstein” have been eliminated using the character alignment analysis module 232 in order to yield the set of characters 208 (in this case, the serial number of the banknote), as shown in FIG. 3F.

It will be appreciated that the spatial analysis engine 226 may include either or both of the character geometry analysis module 228 or the character alignment analysis module 232. In one example in which the spatial analysis engine 226 includes only the character geometry analysis module 228, the character geometry analysis module 228 may identify the set of characters 208 from the set of character candidate forms 224 based on or using the set of character geometry criteria described above. In an embodiment in which the spatial analysis engine 226 includes only the character alignment analysis module 232, the character alignment analysis module 232 may identify the set of characters 208 from the set of character candidate forms 224 using the set of spacing parameters described above. In yet other embodiments, the analysis performed by either or both of the character geometry analysis module 228 or the character alignment analysis module 232 may be performed on the original document image 206, the composite image 216, or the character analysis region 220.

In one embodiment, the document character locator 202 may include a character count verifier 234, which may determine a number of characters in the set of characters 208, and verify that the number of characters in the set of characters 208 meets or exceeds a predetermined minimum number of characters and/or meets or is less than a predetermined maximum number of characters. The minimum and maximum number of characters used by the character count verifier 234 may be predetermined based on a known or approximate number of characters in the set of characters 208 that is expected. For example, in FIG. 3, it may be known how many characters are contained in the serial number 208, in which case the character count verifier 234 may threshold lower and upper limits to ensure that the serial number 208 that is found by the document character locator 202 falls within these lower and upper limits. In particular, the serial number 208 shown in FIG. 3G includes 8 characters, and the character count verifier 234 may have a predetermined minimum number of 7 and a predetermined maximum number of 9 and determine that the serial number 208 is verified to be the serial number because the serial number 208 contains 8 characters, which exceeds the predetermined minimum number and is less than the predetermined maximum number. In another example, the minimum and maximum number used by the character count verifier 234 may be 8, such that only a serial number that has 8 characters (meets both the minimum and maximum numbers) will be verified as the correct serial number 208.

The document character locator 202 may also include an anchor module 236, which may output a location of the set of characters 208 located by the document character locator 202. In one embodiment, the anchor module 236 may determine an anchor parameter, represented as anchor 238 in FIG. 3G, which corresponds to a location of the set of characters 208. The anchor module 236 may then output the anchor parameter 238. In one embodiment, the anchor parameter 238 may represent the point within or around the set of characters 208 that the serial number locator 202 may return or output. For example, the anchor parameter 238 may correspond to a location within the set of characters 208, and may be a value such as top left, top right, bottom left, bottom right, center, etc. In the non-limiting example of FIG. 3G, the anchor parameter 238 is determined and outputted to be the bottom left of the serial number 208, and the anchor module 236 may return this anchor parameter 238 as an outputted value.

The location of the set of characters 208, as indicated by the anchor parameter 238, may be used by subsequent processing steps (e.g., optical character recognition, text-to-speech technology, etc.) as an indication of the location of the set of characters 208. In the non-limiting example in which the set of characters 208 located by the document character locator 202 is a serial number, as shown in FIGS. 3A-G, once the location of the serial number 208 is determined by the document character locator 202 and outputted by the anchor module 236, subsequent processing steps may use the located serial number 208 to determine an authenticity or identity of the banknote on which the serial number 208 is located.

Referring to FIG. 4, an illustrative embodiment of a process for locating a set of characters on a document, which may be performed by the document character locator 102, 202 in FIGS. 1 and 2, may receive an image of a document (step 301). The process may identify a set of character candidate forms in the image based on image intensity data (step 303). The process may identify a set of characters from the set of character candidate forms based on spatial characteristics of the set of character candidate forms (step 305). The process may then output a location of the set of characters (step 307).

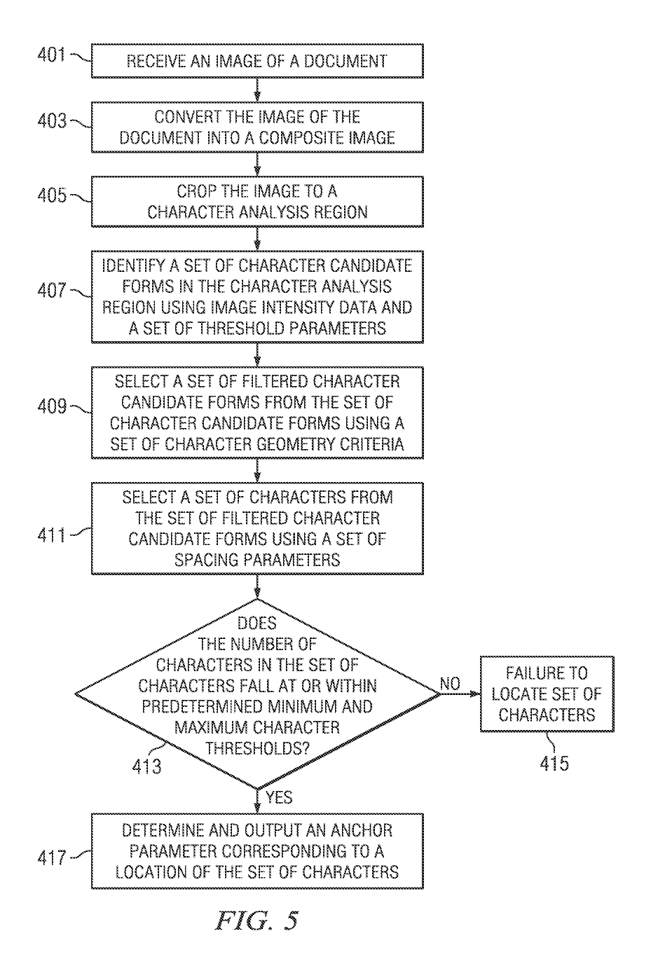

Referring to FIG. 5, an illustrative embodiment of a process for locating a set of characters in a document, which may be performed by the document character locator 102, 202 in FIGS. 1 and 2, may include receiving an image of the document (step 401). The process may convert the image of the document into a composite image (step 403). In one alternative embodiment, the process may skip step 403 if the image of the document is originally a monochrome image.

The process may crop the image to a character analysis region (step 405). The process may identify a set of character candidate forms in the character analysis region using image intensity data and a set of threshold parameters (step 407). The process may select a set of filtered character candidate forms from the set of character candidate forms using a set of character geometry criteria (step 409). The process may also select a set of characters from the set of filtered character candidate forms using a set of spacing parameters (step 411).

The process may determine whether the number of characters in the set of characters falls at or within predetermined minimum and maximum character thresholds (step 413). If the process determines that the number of characters in the set of characters does not fall at or within the predetermined minimum and maximum character thresholds, the process may fail to locate the set of characters (step 415), or try executing another processing step. Returning step 413, if the process determines that the number of characters in the set of characters falls at or within the predetermined minimum and maximum character thresholds, the process may determine and output an anchor parameter corresponding to a location of the set of characters (step 417).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

Referring to FIG. 6, a block diagram of a computing device 502 is shown in which the illustrative embodiments may be implemented. The computing device 502 may be the computing device 104 described in FIG. 1, or part of a document or banknote processing machine. In another embodiment, the document character locator 102 or 202 described in FIG. 1 or 2, respectively, may be implemented on the computing device 502. Computer-usable program code or instructions implementing the processes used in the illustrative embodiments may be located on the computing device 502. The computing device 502 includes a communications fabric 503, which provides communications between a processor unit 505, a memory 507, a persistent storage 509, a communications unit 511, an input/output (I/O) unit 513, and a display 515.

The processor unit 505 serves to execute instructions for software that may be loaded into the memory 507. The processor unit 505 may be a set of one or more processors or may be a multi-processor core, depending on the particular implementation. Further, the processor unit 505 may be implemented using one or more heterogeneous processor systems in which a main processor is present with secondary processors on a single chip. As another illustrative example, the processor unit 505 may be a symmetric multi-processor system containing multiple processors of the same type.

The memory 507, in these examples, may be, for example, a random access memory or any other suitable volatile or non-volatile storage device. The persistent storage 509 may take various forms depending on the particular implementation. For example, the persistent storage 509 may contain one or more components or devices. For example, the persistent storage 509 may be a hard drive, a flash memory, a rewritable optical disk, a rewritable magnetic tape, or some combination of the above. The media used by the persistent storage 509 also may be removable. For example, a removable hard drive may be used for the persistent storage 509.

The communications unit 511, in these examples, provides for communications with other data processing systems or communication devices. In these examples, the communications unit 511 may be a network interface card. The communications unit 511 may provide communications through the use of either or both physical and wireless communication links.

The input/output unit 513 allows for the input and output of data with other devices that may be connected to the computing device 502. For example, the input/output unit 513 may provide a connection for user input through a keyboard and mouse. Further, the input/output unit 513 may send output to a processing device. In the case in which the computing device 502 is a cellular phone, the input/output unit 513 may also allow devices to be connected to the cellular phone, such as microphones, headsets, and controllers. The display 515 provides a mechanism to display information to a user, such as a graphical user interface.

Instructions for the operating system and applications or programs are located on the persistent storage 509. These instructions may be loaded into the memory 507 for execution by the processor unit 505. The processes of the different embodiments may be performed by the processor unit 505 using computer-implemented instructions, which may be located in a memory, such as the memory 507. These instructions are referred to as program code, computer-usable program code, or computer-readable program code that may be read and executed by a processor in the processor unit 505. The program code in the different embodiments may be embodied on different physical or tangible computer-readable media, such as the memory 507 or the persistent storage 509.

Program code 517 is located in a functional form on a computer-readable media 519 and may be loaded onto or transferred to the computing device 502 for execution by the processor unit 505. The program code 517 and the computer-readable media 519 form computer program product 521 in these examples. In one embodiment, the computer program product 521 is the document character locator 102 or 202 described in FIGS. 1 or 2, respectively. In this embodiment, the program code 517 may include computer-usable program code capable of receiving an image of a document, identifying a set of character candidate forms in the image based on image intensity data, identifying a set of characters from the set of character candidate forms based on spatial characteristics of the set of character candidate forms, and outputting a location of the set of characters.

In another embodiment, the program code 517 may include computer-usable program code capable of receiving an image of a banknote, identifying a set of character candidate forms in the image based on image intensity data, identifying a serial number from the set of character candidate forms based on spatial characteristics of the set of character candidate forms, and outputting a location of the serial number. Any combination of the above-mentioned computer-usable program code may be implemented in the program code 517, and any functions of the illustrative embodiments may be implemented in the program code 517.

In one example, the computer-readable media 519 may be in a tangible form, such as, for example, an optical or magnetic disc that is inserted or placed into a drive or other device that is part of the persistent storage 509 for transfer onto a storage device, such as a hard drive that is part of the persistent storage 509. In a tangible form, the computer-readable media 519 also may take the form of a persistent storage, such as a hard drive or a flash memory that is connected to the computing device 502. The tangible form of the computer-readable media 519 is also referred to as computer recordable storage media.

Alternatively, the program code 517 may be transferred to the computing device 502 from the computer-readable media 519 through a communication link to the communications unit 511 or through a connection to the input/output unit 513. The communication link or the connection may be physical or wireless in the illustrative examples. The computer-readable media 519 also may take the form of non-tangible media, such as communication links or wireless transmissions containing the program code 517. In one embodiment, the program code 517 is delivered to the computing device 502 over the Internet.

The different components illustrated for the computing device 502 are not meant to provide architectural limitations to the manner in which different embodiments may be implemented. The different illustrative embodiments may be implemented in a data processing system including components in addition to or in place of those illustrated for computing device 502. Other components shown in FIG. 6 can be varied from the illustrative examples shown.

As one example, a storage device in the computing device 502 is any hardware apparatus that may store data. The memory 507, the persistent storage 509, and the computer-readable media 519 are examples of storage devices in a tangible form.

In another example, a bus system may be used to implement the communications fabric 503 and may be comprised of one or more buses, such as a system bus or an input/output bus. Of course, the bus system may be implemented using any suitable type of architecture that provides for a transfer of data between different components or devices attached to the bus system. Additionally, the communications unit 511 may include one or more devices used to transmit and receive data, such as a modem or a network adapter. Further, a memory may be, for example, the memory 507 or a cache such as found in an interface and memory controller hub that may be present in the communications fabric 503.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A method for locating characters on a document, the method comprising:
receiving an image of a document;
identifying a set of character candidate forms in the image based on image intensity data;
identifying a set of characters from the set of character candidate forms based on spatial characteristics of the set of character candidate forms; and
outputting a location of the set of characters.

2. The method of claim 1, further comprising:
converting the image of the document into a composite image;
wherein identifying the set of character candidate forms in the image based on image intensity data comprises identifying the set of character candidate forms in the composite image based on image intensity data.

3. The method of claim 2, wherein the composite image is a grayscale image.

4. The method of claim 1, further comprising:
cropping the image to a character analysis region;
wherein identifying the set of character candidate forms in the image based on image intensity data comprises identifying the set of character candidate forms in the character analysis region based on image intensity data.

5. The method of claim 1, wherein identifying the set of character candidate forms in the image based on image intensity data comprises identifying the set of character candidate forms in the image using a set of threshold parameters.

6. The method of claim 5, wherein the image intensity data comprises grayscale intensity values;
wherein the set of threshold parameters comprises at least one of a minimum grayscale threshold or a maximum grayscale threshold; and
wherein identifying the set of character candidate forms in the image comprises determining the set of character candidate forms in the image having at least one of (1) a grayscale intensity value at or above the minimum grayscale threshold or (2) a grayscale intensity value at or below the maximum grayscale threshold.

7. The method of claim 1, wherein identifying the set of characters from the set of character candidate forms based on spatial characteristics of the set of character candidate forms comprises identifying the set of characters from the set of character candidate forms using a set of character geometry criteria.

8. The method of claim 7, wherein the set of character geometry criteria comprises at least one of a height criteria or a width criteria.

9. The method of claim 1, wherein identifying the set of characters from the set of character candidate forms based on spatial characteristics of the set of character candidate forms comprises identifying the set of characters from the set of character candidate forms using a set of spacing parameters.

10. The method of claim 9, wherein the set of spacing parameters comprises at least one of vertical spacing criteria or horizontal spacing criteria.

11. The method of claim 1, wherein identifying the set of characters from the set of character candidate forms based on spatial characteristics of the set of character candidate forms comprises:
selecting a set of filtered character candidate forms from the set of character candidate forms using a set of character geometry criteria; and
selecting the set of characters from the set of filtered character candidate forms using a set of spacing parameters.

12. The method of claim 1, wherein outputting the location of the set of characters comprises:
determining an anchor parameter corresponding to a location of the set of characters; and
outputting the anchor parameter.

13. The method of claim 12, wherein the anchor parameter corresponds to a location within the set of characters, and wherein the anchor parameter is one of top left, top right, bottom left, bottom right, or center.

14. The method of claim 1, further comprising:
determining a number of characters in the set of characters; and
verifying that the number of characters in the set of characters at least one of (1) meets or exceeds a predetermined minimum number of characters or (2) meets or is less than a predetermined maximum number of characters.

15. The method of claim 1, wherein the set of characters is a banknote serial number.

16. A method for locating a serial number on a banknote, the method comprising:
receiving an image of a banknote;
identifying a set of character candidate forms in the image based on image intensity data;
identifying a serial number from the set of character candidate forms based on spatial characteristics of the set of character candidate forms; and
outputting a location of the serial number.

17. The method of claim 16, further comprising:
converting the image of the banknote into a composite image; and
cropping the composite image to a character analysis region;
wherein identifying the set of character candidate forms in the image based on image intensity data comprises identifying the set of character candidate forms in the character analysis region using a set of threshold parameters;
wherein identifying the serial number from the set of character candidate forms based on spatial characteristics of the set of character candidate forms comprises:
selecting a set of filtered character candidate forms from the set of character candidate forms using a set of character geometry criteria; and
selecting the serial number from the set of filtered character candidate forms using a set of spacing parameters; and
wherein outputting the location of the serial number comprises:
determining an anchor parameter corresponding to a location of the serial number; and
outputting the anchor parameter.

18. The method of claim 16, wherein the serial number comprises at least one of a number, a letter, or a symbol.

19. A document character locator implemented by a computing device, comprising:
a composite image generator to receive an image of a document and convert the image into a composite image of the document;
an intensity thresholding module to identify a set of character candidate forms in the composite image based on image intensity data;
a spatial analysis engine to identify a set of characters from the set of character candidate forms based on spatial characteristics of the set of character candidate forms; and
an anchor module to output a location of the set of characters.

20. The method of claim 19, wherein the spatial analysis engine further comprises:
a character geometry analysis module to filter the set of character candidate forms to form a set of filtered character candidate forms using a set of character geometry criteria; and
a character alignment analysis module to select the set of characters from the set of filtered character candidate forms using a set of spacing parameters.

21. The method of claim 19, further comprising:
an image cropping module to crop the composite image to a character analysis region.

22. The method of claim 19, further comprising:
a character count verifier to determine a number of characters in the set of characters, and verify that the number of characters in the set of characters at least one of (1) meets or exceeds a predetermined minimum number of characters or (2) meets or is less than a predetermined maximum number of characters.
